(19) United States
(12) Patent Application Publication
(10) Pub. No.: US 2009/0252965 A1
(43) Pub. Date: Oct. 8, 2009

(54) Surface functionalization and coating of flame-generated nanoparticles

(75) Inventors: Murray J. Height, Zurich (CH); Alexandra Teleki Harsanyi, Zurich (CH); Marc File, Zug (CH); Sotiris E. Pratsinis, Zurich (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Eidgenössische Technische Hochschule Zürich, Zürich (CH)

(21) Appl. No.: 11/919,293

(22) PCT Filed: Apr. 28, 2006
(86) PCT No.: PCT/CH2006/000233

§ 371 Date: Jun. 12, 2009

Related U.S. Application Data
(60) Provisional application No. 60/676,434, filed on Apr. 29, 2005.

(51) Int. Cl. B32B 5/16; B05D 7/00; B05D 1/02; B05C 11/00

(52) U.S. Cl. 428/403; 427/212; 427/447; 118/47

(57) ABSTRACT

A method for generating a chemically bonded organic functionality on the surface of particles or for condensing an organic compound onto the particle surface giving an organic coating is described. The method comprises a step of contacting a vapour containing an organic compound and a gaseous process stream containing flame-generated particles so as to react the organic compound with surface groups on the particles to give a chemically bonded organic functionality to the particle surface or so as to result in an organic coating.

### TECHNICAL FIELD

Flame generated particles have a coverage of surface hydroxyl groups (see e.g. Mueller, R., Kammler, H. K., Wegner, K. & Pratsinis, S. E. OH surface density of SiO₂ and TiO₂ by thermogravimetric analysis. Langmuir 19, 160-165 (2003)). These surface groups may undergo reaction with organic molecules to provide surface functionalization. Functional groups anchored to the surface in this manner may enhance solubility in solvents and polymers, and may reduce the degree of particle agglomeration. Here we describe a method to surface functionalize particles in the aerosol phase.

### BACKGROUND OF THE INVENTION

Nanosized powders can be synthesized via the wet chemical route and gas-phase processes. The latter do not involve the expensive steps of solid-liquid separation, washing and drying of the wet chemistry processes. For the gas phase production of commercial quantities of nanoparticles the flame processes are the most widely used methods. The most important of the as produced products are carbon blacks, fumed silica as well as pigmentary titania.

Nanoparticles incorporated in polymers find a broad band of applications. The particles can perform as light and heat absorbants, improve gas permeability or enhance mechanical strength and abrasion resistance of the polymers etc.

Functionalized surfaces of such particles promise advances in this field. Besides an improved dispersion, coatings etc. can strengthen interfacial interactions when chemical bondings are established.

Some techniques commonly used to coat nanoparticles with a polymer are the supercritical-anti-solvent process, emulsification or the solvent evaporation technique. These processes functionalize the particles in a post-synthesis, wet phase treatment and have the problem of solvent waste. Another process called atomic layer deposition technique is interesting because it has the possibility to do multi-layer coatings on particles.

There are three or four possible pathways for surface reactions with hydroxyl groups.

### 1. Silylation

### 2. Esterification

### 3. Amidization

Of these the silylation approach is likely to give the best performance in vapour-phase processing as the other techniques are generally used in liquid phase with catalysts and buffering reagents.

The reaction between a surface hydroxyl group and a silane compound yields a surface grafted silane group and an alcohol (see FIG. 1).

Silylation reactions have been performed successfully in the vapour-phase using trimethylchlorosilane (TCMS) and trimethylethoxysilane (TMES) (see e.g. Sever, R. R., Alcala, R., Dumesic, J. A. & Root, T. W. Vapor-phase silylation of MCM-41 and Ti-MCM-41. Microporous and Mesoporous Materials 66, 53-67 (2003)). Temperatures above 200° C. are necessary to give significant surface reaction. The nozzle temperature of the flame-generated particles would be expected to be higher than 200° C. The silylation reaction is ideally performed under anhydrous conditions so this may be an issue for particle functionalization in the post-flame region.

The main references discussing vapour-phase surface modification, treatment or functionalization are listed in Table 1 below. The described processes achieve surface modification of particles via reaction with the vapour-phase, wherein in each of the systems the surface functionalization is carried out on particles produced in a separate synthesis stage.

TABLE 1
Journal article prior art summary.

| Authors | Title | Method | Comment |
|---|---|---|---|
| Arpagaus et al. | A downer reactor for short-time | Plasma reactor | Plastic particles. |
| (2005) | plasma surface modification of | | Low exposure |
| | polymer powders | | time (0.1 s). |
| Jung et al. | Surface modification of fine powders | Fluidized bed | Silica film coating. |
| (2004) | by atmospheric pressure plasma in a | | |
| | circulating fluidized bed reactor | | |
| Kim et al. | Vapor-phase surface modification of | Tumbling cone | Vapour-phase in |
| (2004) | submicron particles | in siloxane | solioxane. |
| | | atmosphere | |
| Matsukata et al. | Development of a microwave plasma- | Fluidized bed | Methane gas |
| (1994) | fluidized bed reactor for novel particle | | decompose to |
| | processing | | form carbon |

In Table 1 the following references are discussed: Arpagaus, C., Sonnenfeld, A. E. & von Rohr, P. R. A downer reactor for short-time plasma surface modification of polymer powders. Chemical Engineering & Technology 28, 87-94 (2005); Jung, S. H., Park, S. M., Park, S. H. & Kim, S. D. Surface modification of fine powders by atmospheric pressure plasma in a circulating fluidized bed reactor. Industrial & Engineering Chemistry Research 43, 5483-5488 (2004); Kim, Y. E., Kim, S. G., Shin, H. J., Ko, S. Y. & Lee, S. H. Vapor-phase surface modification of submicron particles. Powder Technology 139, 81-88 (2004); Matsukata, M., Suzuki, K, Ueyama, K. & Kojima, T. Development of a microwave plasma-fluidized bed reactor for novel particle processing. International Journal of Multiphase Flow 20, 763-773 (1994).

A summary of patent disclosures in this field is listed in Table 2.

TABLE 3
Patent prior art summary.

| Patent | Authors | Method | Comment |
|---|---|---|---|
| U.S. Pat. No. 5,357,005 | Buchwalter et al. (1994) | Water vapour plasma | Treat plastic |
| | | | surfaces only |
| U.S. Pat. No. 6,660,338 | Hargreaves (2003) | Organic solution and silane mixture. | Wet phase. |
| U.S. Pat. No. 6,444,268 | Lefkowitz et al. (2002) | Silane mixture. All examples are in wet- | Requires a silane |
| | | phase. | mixture. |
| U.S. Pat. No. 6,258,454 | Lefkowitz et al. (2001) | Silane mixture. Specific to polystyrene, | Specific |
| | | agarose, dextran, cellulosic polymers, | substrates. |
| | | polyacrylamides, and glass. | |
| U.S. Pat. No. 6,194,028 | Horiuchi et al. (2001) | Condense surface improving agent from | Condensation. |
| | | supersaturated vapour onto particle | |
| | | surface. | |
| U.S. Pat. No. 5,665,511 | Imal et al. (1997) | Amino group compound as coupling | Amino group and |
| | | agent to inorganic particles for | specific to |
| | | photographic dry developer. | developer |
| | | | powder. |
| U.S. Pat. No. 6,444,326 | Smith (2002) | Surface first coated with amorphous silica | Coat with silica |
| | | from silicon hydride then functionalized | first. |
| | | with an unsaturated hydrocarbon. | |
| JP2002363032 | Horiuchi et al. (2002) | Condense from supersaturated vapour of | Condensation |
| | | fatty acid onto the cosmetic particle. | |
| JP11256069 | Morimoto et al. (1999) | Monomer 1 incorporated into particle | Multiple steps |
| | | then monomer 2 is condensed onto | and monomers. |
| | | surface where monomers react to form | |
| | | polymer coating. | |
| JP2004338969; | Kudo et al. (2004) | Silane treatment of silica-titania particles. | Wet-phase |
| EP1477532 | | | treatment. |
| JP6024730 | Inomata et al. (1994) | Particles dispersed into | Wet-phase |
| | | water/alcohol/silane mixture. | |
| JP63039967 | Iwayama et al. (1988) | Steam treated silica then reacted with | 2 step. Wet- |
| | | vinyltrimethoxysilane in alcohol. | phase. |
| JP 63040717 | Iwayama et al. (1988) | Heat treatment in water/alcohol to | Wet-phase |
| | | increase surface OH content. | |

Most patents describing surface functionalization, modification or treatment of particles relate to wet-phase processes. Silylation is a commonly employed technique however the majority of patents referring to this use the wet-phase approach.

The most relevant patent of these seems to be U.S. Pat. No. 6,444,268 (Lefkowitz et al., 2002) which describes a generic approach using a mixture of silanes. This patent is general to many surfaces and many treatment compounds.

### SUMMARY OF THE INVENTION

Desired properties of functionalized flame-generated particles are as follows:
Solubility in organic solvents or water
Solubility in various polymers
Ability to undergo further functionalization using wet chemistry once particles are dispersed in a solvent.
Ability to directly graft surface-functionalized particles onto the surface of macro-scale materials.

Criteria for choice of a suitable silane compound:
(Preferably) Liquid between 0° C. and room temperature.
Reasonable vapour pressure at room temperature and atmospheric pressure. Which essentially means, normally boiling points between 50 and 150° C.
Long organic tail chains on the siloxane are preferable (propyl, butyl . . . )
Multiple methoxy or ethoxy headgroups will give increased likelihood of reaction with surface OH groups (di- or trimethoxy, di- or triethoxy).
Preferably low-flammability (high flash-point), low toxicity and hazard ratings.

### Silane Shortlist:

The following silane compounds are examples of suitable Trimethoxysilanes or Triethoxysilanes with relatively low toxicity, hazard rating, and flammability (Table 3).

TABLE 3
Example silane compounds suitable for surface functionalization of flame-made particles.

| | | | Boiling Pt (B. Pt) | |
|---|---|---|---|---|
| | | | Flash Pt. (F. Pt) | |
| | | | Vapour Pr. | |
| Structure | Name | CAS # | (Pvap) | Comment |
| 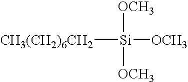 | Trimethoxy(octyl)silane | 3069-40-7 | BPt: 192 C. Flash Pt: 98 C. Pvap: 0.7 mmHg at 25 C. | Irritant |
| 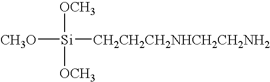 | [3-(2-Aminoethylamino)propyl] trimethoxysilane | 1760-24-3 | BPt: 262 C. Flash Pt: 68 C. Pvap: <5 mmHg (at 25 C.) | Irritant |
| 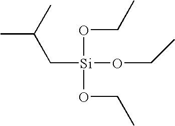 | isobutyltriethoxysilane | 17980-47-1 | BPt: 165 C. Flash Pt 63 C. Pvap: — | Irritant |
| 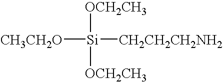 | 3-aminopropyltriethoxysilane | 919-30-2 | BPt: 213 C. Flash Pt: 98 C. Pvap: <10 mmHg at 100 C. | Causes burns |

### Process Principles:

One of the key principles involved in this process is to react suitable organic precursor compounds delivered in the vapour-phase with surface groups on discrete particles transported in the aerosol phase. The desired outcome is to chemically immobilize a targeted organic group onto the particle surface, yielding particles with surface properties suitable for dispersion in organic solvents and polymers and direct grafting of particles onto the surface of other materials. An alternative strategy that may be employed in some circumstances is to condense organic vapours directly onto the particles while in the aerosol phase.

The following principles are critical to facilitate the reaction between the particles and the organic-vapour.
Sufficient organic vapour concentration to achieve effective surface coverage of the particles.
Sufficient temperature to achieve effective reaction or condensation.
Sufficient contact time at the desired temperature.

The process configuration capable of achieving these principles can be quite varied in design, however, the system should give controlled contact between the organic compound vapour stream and the gas stream containing the aerosol of particles. The contacting region should be positioned so as to enable control of temperature and contact time between these process streams. For surface functionalization of flame-generated particles the system should ideally be positioned directly downstream from the burner system where particle synthesis occurs as this would provide sufficient temperature for reaction and the particles are well dispersed as an aerosol. Suitable configurations may include a simple tube reactor; a porous tube wall with organic vapour issued through the porous wall; direct contacting nozzles mixing the gas streams, and other configurations serving the key principles listed above. An example embodiment of a suitable process configuration is based on a quenching nozzle design previously demonstrated in conjunction with a particle synthesis burner system (Wegner, K., Stark, W. J. & Pratsinis, S. E. Flame-nozzle synthesis of nanoparticles with closely controlled size, morphology and crystallinity. Materials Letters 55, 318-321 (2002)). The nozzle 7 can be placed at suitable distances directly above the burner nozzle 1 and provides a convenient means of controlling particle flow and gas-stream temperature. A porous tube (or simply a tube with small holes or openings in its walls, e.g. perforated tube) and flow-directing housing positioned at the opening of the nozzle enables the organic vapour stream to be issued directly into the particle aerosol stream, giving intimate mixing with the hot gas stream giving conditions suitable for surface reactions to occur. The mixed gas stream containing both particles and the precursor vapour is then drawn into a chamber where reaction can proceed further together with gas-stream cooling. FIG. 2 shows a schematic of this example process configuration.

The following secondary factors are also important considerations:
Flammability of the organic vapour
Susceptibility to side reactions with water, other precursor compounds, and the reactor itself.
Ability to vapourize sufficient precursor to give sufficient vapour concentration
Possibility to direct condensation of organic onto the particle without chemical reaction.

### Inventive Step:

The inventive step described here is the direct (in-situ) surface functionalization of flame-made particles in a vapour-phase processing step directly following (in short time and with no additional handling step) particle synthesis.

In principle the present invention relates to a method for generating a chemically bonded organic functionality on the surface of particles or for condensing an organic compound onto the particle surface giving an organic coating. The essence of the invention is to combine the particle generation in a flame process with the generation of the functionality or the coating. Therefore, the method comprises a step of contacting a vapour containing an organic compound and a gaseous process stream containing flame-generated particles so as to react the organic compound with surface groups on the particles to give a chemically bonded organic functionality to the particle surface or so as to result in an organic coating.

So there is the possibility of a chemical reaction with the surface or physically coating the particles, or also combinations thereof. While below the discussion focuses on hydroxyl groups on the particle surfaces and silylation reactions, also additional different reaction schemes can be carried out beyond OH groups and silylation, like e.g. the chemical functionalization of any surface group which is chemically reactive (e.g. NH₂, SH etc.) with other suitable reactions with organic compounds.

Also, the organic moiety may be selected with a tail group that is suited to additional chemical modification in subsequent (liquid based) reactions, e.g. to increase the hydrophobicity of the coated particles or to allow subsequent specific modification of the tails. The organic moiety may also be selected with a specific active tail group carrying active structures like pharmaceutically active tails, colour-active tails, etc.

According to a first preferred embodiment of the invention, a contacting system is positioned directly following the particle synthesis step where the particle-bearing gas stream contains residual temperature from the flame above 100° C., and preferably below the decomposition/flame temperature of the organic compound in the vapour phase. Or more generally, the vapour containing an organic compound is contacted with the gaseous process stream directly following the particle synthesis step. The flow path between the flame of the particle synthesis and the introduction of the organic compound in the vapour phase is adjusted such that the particles are allowed to cool to a temperature which is above 100° C. such as to avoid problems with water, but below the decomposition temperature of the organic compound in the vapour phase. In addition to that, the flame-made particles should remain an aerosol. Depending on the desired process (coating, chemical reaction) the temperature can be adjusted to suit. It is on the other hand also possible to introduce an organic compound which only decomposes upon introduction into the process stream in order to chemically react with the surface of the particles. In this case the upper limit of the temperature at the position of the introduction of the vapour comprising the organic compound should be adjusted to be above this decomposition temperature but below the decomposition temperature of the fragments generated.

Preferably, the organic compound is a silane compound, preferably R-trimethoxysilane and/or R-triethoxysilane where R is any organic moiety C1 or higher. Even more preferably the organic compound is selected from the group of Trimethoxysilanes or Triethoxysilanes such as Trimethoxy(octyl)silane, [3-(2-Aminoethylamino)propyl] trimethoxysilane, Octyltriethoxysilane, Isobutyltriethoxysilane, 3-Aminopropyltriethoxysilane or mixtures thereof. Depending on the functionality to be attached or coated onto the particles correspondingly therefore also mixtures of organic compounds are possible, as well as compounds supplemented with additives, stabilisers, activators, colourants etc.

As already outlined above, preferably the particle synthesis step is a vapour flame, flame spray pyrolysis, or any other particle-generating combustion system. The term particles shall include not only particles based for example on silica, titania etc, but it shall also include flame-generated carbon particles like soot, fullerenes, carbon-nanotubes, and the like.

According to a further preferred embodiment of the methods the contacting system is a direct gas mixing chamber. The contacting system may consist of or comprise a porous and/or perforated, preferably cylindrical (metal or ceramics) tube with organic vapour issued through the porous and/or perforated wall, preferably in a direction towards the main axis of the contacting system. The contacting system may also be a cyclone.

The functionalized particles are preferably subsequently washed and/or dispersed in solvents, polymers, or grafted onto surfaces. The choice of silane compound can be tailored to achieve a desired particle solubility or reactivity.

The functionalized and/or coated particles can be deposited onto a substrate or article to give a polymer composite layer. They can also be incorporated into a matrix, for example into a polymer matrix, which polymer matrix can subsequently be further treated to yield fibres, coatings, moulded articles etc.

According to a preferred embodiment of the invention, the particles are based on silica and/or titania and/or zinc oxide and/or carbon, wherein preferably the particles are generated in a flame of a diffusion burner, which preferably comprises a multitude of concentrical tubes. Typically, a particle precursor substance is fed to the flame via the central tube, and oxygen and combustion gas are fed to the flame via a first outer annulus and a second outer annulus, respectively.

Generally speaking, for the flame spray pyrolysis technique, the particle precursor substance can also be a liquid mixture, so it is for example possible to generate silica or titania particles comprising silver by the provision of a correspondingly tailored mixture, and it is on the other hand also possible to introduce several precursor substances concomitantly into the flame to lead to particles of multiple components and complex morphologies.

Preferably, the particles are silica particles, and even more preferably a siloxane such as hexamethyldisiloxane (HMDSO) or tetraethoxyorthosilicate (TEOS), possibly supplemented by additives, is used as the particle precursor substance.

In order to achieve the above temperature conditions, preferably the distance (BND) between the burner and the contacting system (or the location of introduction of the vapour comprising the organic compounds) for contacting the vapour containing an organic compound and the gaseous process stream containing flame-generated particles is smaller than 10 cm, preferably in a range of 2-7 cm. The choice of height in general will be dictated by the temperature criteria for the surface functionalization nozzle, and will be determined by the desired temperature and flow characteristics of the particles for the reaction/coating by the organic component. The method is to be seen general enough to account for large and small flames where the nozzle positioning can be at very different heights as long as the temperature conditions are suitable for the reaction/coating. The position will be generally dictated by the temperature requirements and the height of the flame involved.

Preferably, the vapour containing an organic compound is carried by a carrier gas stream, wherein preferably this carrier gas stream has a flow rate in the range of 0.05-0.8 l/min. The vapour containing an organic compound can be made by means of a bubble saturator system comprising the organic compound as a liquid, through which the stream of carrier gas is bubbled.

According to a further preferred embodiment, the vapour containing an organic compound is added to the gaseous process stream containing flame-generated particles downstream of a quenching nozzle. The quenching nozzle typically comprises an orifice with a diameter in the range of 1 to 3 mm, preferably in the range of 1.5 mm, wherein even more preferably said quenching nozzle comprises a cooling system.

The organic compound is in the alternative or in addition to that added to the gaseous process stream via a slit provided concentrically to the main axis of the process stream. Preferably the slit has a width in the range of 0.1 to 1 mm, preferably in the range of 0.5 mm, wherein even more preferably the width of said slit is adjustable.

The present invention also relates to particles with a chemically bonded organic functionality on the surface or with an organic compound condensed onto the particle surface giving an organic coating obtainable or obtained according to a process as given above.

Furthermore, the present invention relates to a device for carrying out a method as given above, comprising at least one burner for the flame generation of particles, comprising at least one device for the introduction of a vapour containing at least one organic compound into the process stream comprising the generated particles, wherein said device is located substantially immediately downstream of said burner, said device being preferably distanced from the nozzle of the burner by no more than 10 cm (wherein again, the position will be generally dictated by the temperature requirements and the height of the flame involved), and comprising at least one gas-solid separation device (eg. Filter) downstream of said device for removing the treated particles from the process stream, wherein preferably means (like e.g. a vacuum pump) are provided for facilitating the collection and transmission of the process stream through said separation device. Preferably between the burner and the location of introduction of a vapour containing an organic compound into the process stream comprising the generated particles there is located a quenching nozzle for control of temperature.

Further preferred embodiments of the present invention are given in the dependent claims.

### SHORT DESCRIPTION OF THE FIGURES

In the accompanying drawings preferred embodiments of the invention are shown in which:

FIG. 1 shows an idealized reaction between an OH group on a particle surface reacting with an silane-based organic compound;

FIG. 2 is a schematic diagram of an example process configuration for surface functionalization of flame-generated particles;

FIG. 3 is a detailed diagram of an example process configuration for surface functionalization of flame-generated particles including precursor delivery, particle collection and organic compound delivery system;

FIG. 4 arrangement for adding the organic vapour to the aerosol: arrangement Z adds the organic vapour to the aerosol before the quenching process;

FIG. 5 arrangement for adding the organic vapour to the aerosol: arrangement Q adds the organic vapour to the aerosol after the quenching process;

FIG. 6 arrangement for adding the organic vapour to the aerosol: arrangement mf55, a) axial cut, b) radial cut;

FIG. 7 arrangement for adding the organic vapour to the aerosol: arrangement mf55, cooling, a) axial cut, b) radial cut;

FIG. 8 Raman curves of the reference materials;

FIG. 9 Raman curves of samples made with arrangement Q at increasing ArOTES rates;

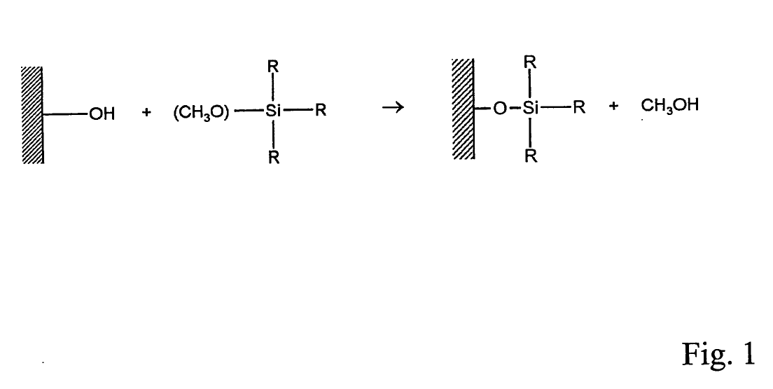

### DETAILED DESCRIPTION OF THE PREFERRED EMBODIMENTS

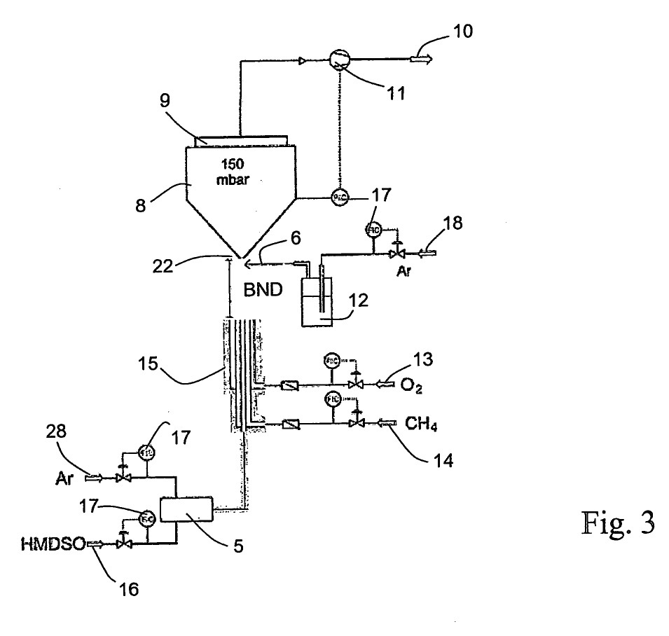

Referring to the drawings, which are for the purpose of illustrating the present preferred embodiments of the invention and not for the purpose of limiting the same, FIG. 3 shows the reactor system used for the particle synthesis.

For the production of silica nanoparticles hexamethyldisiloxane 16 (HMDSO) is fed at a flow rate of 6.5 g/h to the evaporator 5. The evaporator 5 opening is 14.2% and its temperature is set to 75° C. The HMDSO vapour is carried by 0.3 l/min argon 28 to the center tube of the burner 15. All hoses leading to the single diffusion burner are heated to 75° C. to prevent condensation of the vapour. The burner 15 itself is heated to 75° C. by an oil pump system. 2.0 l/min oxygen 13 and 0.5 l/min methane 14 flow through the outer and inner annulus of the burner 15 respectively.

A vacuum pump 11 maintains a negative pressure of 150 mbar in the filter housing 8. Particles are accumulated on a glassfiber filter 9 over a 5 min collection time. A nozzle of 1.5 m in diameter quenches the flame rapidly before expansion of the aerosol takes place in the filter house. 7-9 l/min ambient air are drawn into the nozzle with the flame as measured by Wegner and Pratsinis (Wegner, K., and S. E. Pratsinis, “Nozzle-Quenching Process for Controlled Flame Synthesis of Titania Nanoparticles”, AIChE Journal, 49, 1667-1675 (2003)). The burner nozzle distance (BND) is varied between values of less than 10 cm, in particular between 5 and 9 cm. The process parameters reported by Wegner (Wegner, K., “Nanoparticle Synthesis in Gas-Phase Systems: Process Design and Scale-up for metals and metal oxides”, Diss. ETH No. 14568, (2002)) are applied for the silica production with the quenching nozzle 22.

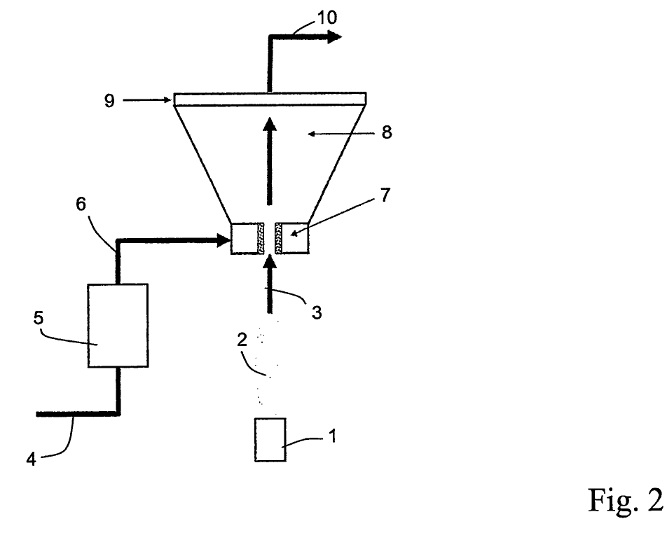

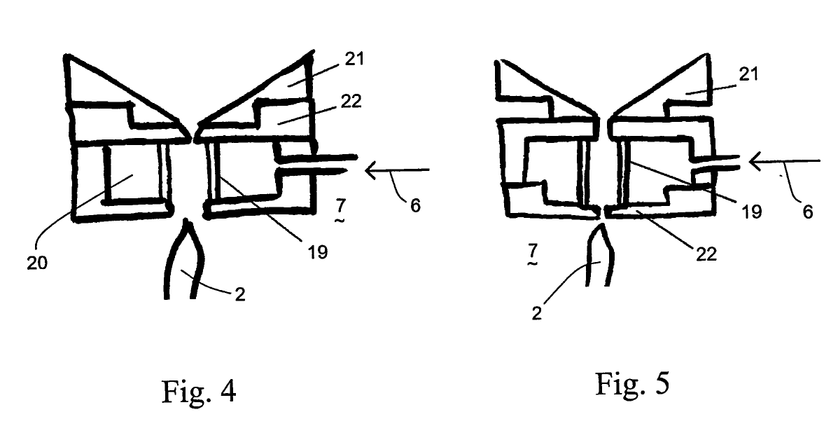

A bubble saturator 12 is installed to feed organic vapour 6 in the area of the quenching nozzle 22. The argon flow rate (reference numeral 4 in FIG. 2) passing through the octyltriethoxysilane (OTES)-filled bubble saturator 12 is 0.05-1.001/min (combined flow designated as ArOTES). The bubbling system 12 is operated at ambient temperature. Depending on the organic vapour feed arrangement (FIGS. 4, 5) the pressure in the bubble saturator is 1.013 or 0.150 bar.

Two different arrangements shown in FIGS. 4 and 5 were used to add the organic vapour to the aerosol.

FIG. 4 shows arrangement Z where the organic vapour is added to the aerosol before the quenching nozzle. A small slit of 12.6 mm² at the interface of the nozzle provides the organic vapour feed.

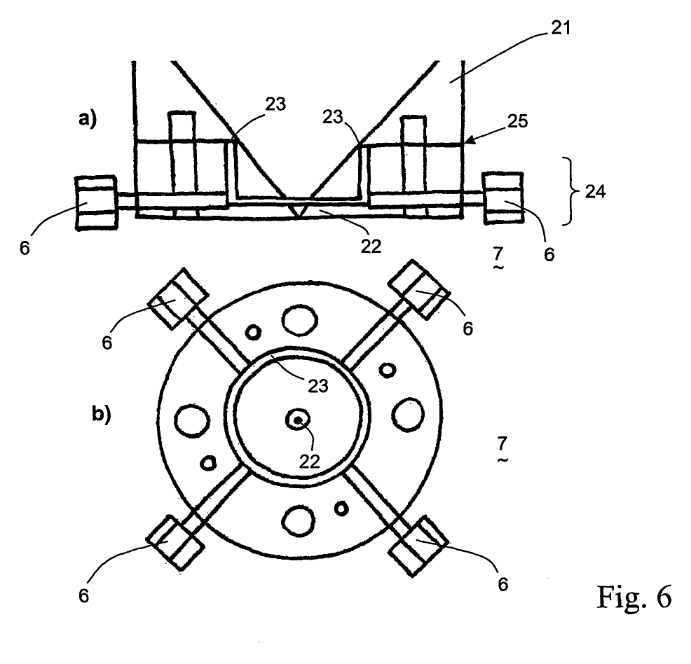

FIG. 5 shows arrangement Q where the organic vapour is added after the quenching nozzle. Through 16 holes 1 mm in diameter in the cylinder (FIG. 6b) the vapour passes to the quenched aerosol. After 15 mm in the cylinder the mixture reaches the filter house where further expansion takes place.

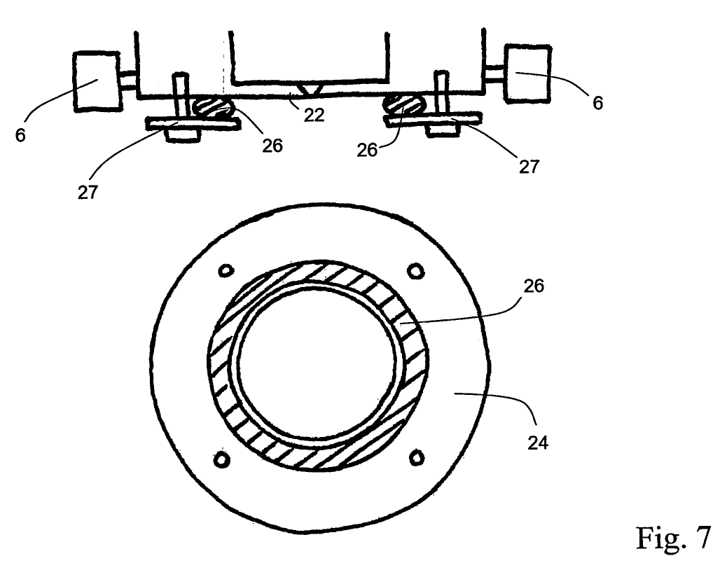

Another option is to manufacture a specific vapour feeder. It mixes the organic vapour with the aerosol at lower temperatures by reduction of the preheating of the organic vapour and by elimination of the hot cylinder area. Additionally the quenching effect can be increased. A technical solution for this, called mf55, is shown in FIGS. 6 and 7.

The design of mf55 is very close to the quenching nozzle. The expansion area behind the quenching nozzle 22 is only extended by a small slit 23 to supply the organic vapour (FIG. 6a). The width of the slit 23 can be adjusted for example around 0.5 mm by the introduction of shims between the filter house and the mf55 (position 25). The organic vapour is supplied symmetrically to the quenching nozzle 22 to maximize vapour-particle mixing and contacting (FIG. 6b).

FIG. 7 shows the cooling ring (dashed area, 26) for less preheating of the organic vapour by the bottom plate. The ambient air drawn into the nozzle is cooled by this ring too and thus the quenching effect of the aerosol through the nozzle 22 is increased. In order to decrease the amount of excess organic vapour at high feeding flow rates a bypass of the bubble saturator 12 can be installed. To avoid contamination of the vacuum pump 11 a cleaning mechanism after the glassfiber filter can be installed.

Different means for the introduction of vapour are possible in particular for large-scale commercial applications such as nozzle grids, etc.

### Particle Synthesis Z

The effect of the OTES vapour feeder geometry on the silica particle producing flame was first studied in the absence of argon through the bubble saturator. The burner nozzle distance (BND) was varied from 5 to 9 cm with particle samples collected at each height position. It was observed that between 7 and 9 cm BND the flame is often not drawn sufficiently into the opening of arrangement Z (FIG. 4). The flame evaded to the left of the opening depositing particles on the lower surface of the vapour feeder. The BET equivalent particle diameter measured at 5 cm BND was 36.4 nm. This value is in agreement with the silica particle synthesis with the quenching nozzle reported by Wegner (2002).

Pure argon was fed through the empty bubble saturator in arrangement Z at 0.05-0.30 l/min. The BND was set to 5 cm assuming sufficient suction of the flame into the filter house when additional argon was fed. The BET (specific surface area) diameters of the product powders varied between 34.6 and 37.3 nm independent of the ArOTES (Argon and OTES vapour) flow rate. After 5 min about 0.25 g of powder was collected from the glassfiber filter. This corresponds to a yield of 61%.

The bubble saturator was then filled with OTES, and argon was fed at 0.05-0.30 l/min through the bubble saturator in arrangement Z resulting in a OTES saturated argon stream (ArOTES). The BND was maintained at 5 cm. The addition of OTES did not affect the BET diameter of the product powders (±1 nm) or the collected mass.

No visual difference to silica powder conventionally produced with the vapour flame reactor and the nozzle quenching process was observed.

### Particle Synthesis Q

Arrangement Q was directly tested with the OTES-filled bubble saturator. The ArOTES rate was varied between 0.05 and 1.00 l/min and the BND adjusted between 4.25 and 5 cm. After every experimental run the cylinder and the nozzle had to be cleaned with ethanol and dried at 150° C.

At 0.05 l/min ArOTES the flame already deposited a significant amount of silica on the lower surface of the arrangement. Frequently the flame deflected to the side of the orifice. Erratic air flow in the containment hood surrounding the flame reactor may be an explanation for this. But using the vacuum pump to maintain a negative pressure in the bubbling system definitely reduces the effectiveness of the nozzle quenching process. Particles are not only lost to the lower surface of the arrangement but also to the inside of the cylinder. Finally 0.17 g of silica was collected from the filter after 5 min. A BET equivalent diameter of 49.5 nm was obtained. This value differs from the previous experiments. In arrangement Q the area after the nozzle where expansion of the aerosol takes place is changed (FIG. 5). The aerosol can only expand after 20 mm behind the nozzle to the filter house. The temperatures behind the nozzle are assumed to be higher with arrangement Q. Both changes may partially explain an extended zone for particle growth. In arrangement Z an area of 12 mm before the quenching nozzle was changed. This geometry does not significantly affect the particle growth conditions in the flame before the quenching nozzle.

Next the ArOTES rate was increased to 0.80 l/min. The mass collected from the filter was 0.26 g. It seemed to be easier to scratch off the powder from the glassfiber filter.

The powder was put in an oven and heated up to 900° C. to oxidise any organic material (ash test). The weight loss of the powder from the ash test was 7.9%. No visual changes to the powder before the ash-test were observed.

Another sample was made with 1.00+ l/min ArOTES. After the production of the flakes 0.05 g powder from the cylinder was collected for Raman analysis.

### Raman Analysis

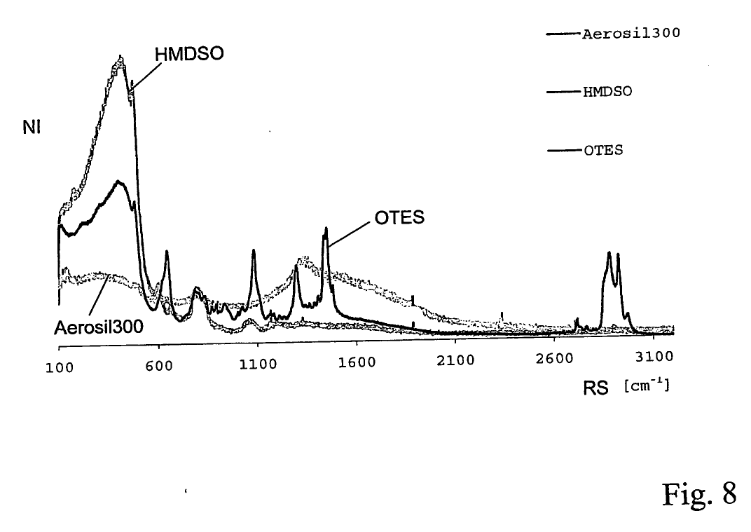

Reference materials of Aerosil300 (Degussa), the precursor liquid HMDSO and liquid OTES were analysed using Raman spectroscopy. The normalized Raman curves of these chemicals are shown in FIG. 8.

The vertical axis of the Raman FIG. 8 indicates the normalized intensity of light scattered from a specific bonding at the corresponding Raman shift (horizontal axis). The discussion of the Raman figures presented here is focusing on peaks between 2900 and 3000 cm⁻¹ Raman shift. Davis et al. (Davis, C. A., P. R. Graves, P. C. Healy, and S. Myhra, “Analysis of surface silylation reactions by Raman spectroscopy”, Applied Surface Science, 72, 419-426 (1993)) report that these peaks are specific for C—H bondings in silica-O—Si(CH₃)₃ compounds.

Uncoated silica like Aerosil300 does not show any peaks in the range of 2900-3000 cm⁻¹. Two peaks for the symmetric and anti-symmetric C—H stretching mode of OTES were detected (Davis et al., 1993). Because of the low concentration of the C—H bondings HMDSO shows only a small peak between 2900 and 3000 cm⁻¹. This facilitates the distinction of organic material supplied through the bubble separator system to unreacted HMDSO possibly present in the powders.

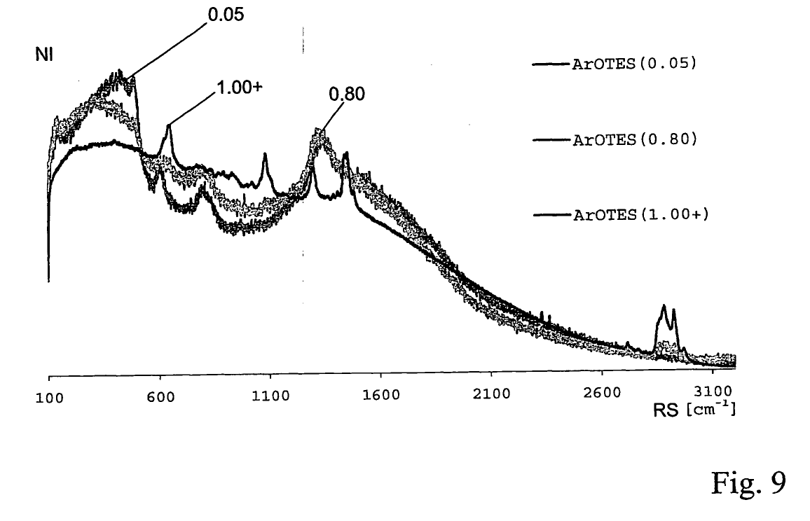

FIG. 9 shows three Raman curves of samples made with arrangement Q and an OTES-filled bubble saturator. At an ArOTES rate of 0.05 l/min no effect can be observed on the Raman curve. By increasing the ArOTES rate to 0.80 l/min the peaks for C—H bondings are found between 2900 and 3000 cm⁻¹ indicating organically modified silica. The curve of the flakes (1.00+ l/min ArOTES) shows peaks of higher intensity between 2900 and 3000 cm⁻¹. Also peaks at lower Raman shifts appear, similarly to liquid OTES. It is assumed that some organic material from the wall of the contaminated filter housing was added to the particles directly on the filter without having contacted the hot aerosol in the nozzle section.

### CONCLUSIONS

Organically modified silica nanoparticles can be produced using a vapour flame reactor with a bubbling system for the organic vapour feed. The Raman curves of the modified samples show peaks between 2900 and 3000 cm⁻¹ Raman shift indicating the presence of C—H bondings. The organic vapour should be added after the nozzle quenching process to prevent decomposition. With such an arrangement the burner nozzle distance had to be adjusted below 5 cm so the flame was sufficiently drawn into the nozzle.

The critical carrier gas flow rate to see an organic effect on the powder lies somewhere between 0.05 and 0.80 l/min with arrangement Q. Clogging of the nozzle can be a problem with this arrangement. A considerable amount of particles can get lost to the walls of the cylinder inside the vapour feeder remaining unmodified. An excess of organic vapour feed may result in wet filters and gel-like samples might then be collected. Such samples contain water as well as organic material. An organically modified powder showed initially an improved dispersion behavior compared to pure silica after mixing in hexane. The powders can subsequently be washed.

### LIST OF REFERENCE NUMERALS

1 burner
2 flame
3 post flame gas stream containing particles
4 carrier gas (e.g. N₂, Ar)
5 organic precursor evaporator
6 gas stream containing organic vapour
7 nozzle for mixing of gas streams
8 quenching nozzle housing
9 particle collection filter, glass fibre filter
10 exhaust gas
11 vacuum pump
12 bubbler, bubble saturator device, filled with liquid organic precursor OTES
13 oxygen inlet for diffusion flame
14 methane inlet for diffusion flame
15 diffusion flame burner
16 particle precursor inlet
17 control
18 carrier gas inlet
19 cylinder
20 toroidal space
21 filter housing
22 quenching nozzle
23 slit
24 mf55
25 optional positioning of shims
26 cooling ring
27 holding means for 26
28 carrier gas (e.g. N₂, Ar)
BND burner nozzle distance
NI normalised intensity
RS Raman shift (cm⁻¹)

1. A method for generating a chemically bonded organic functionality on the surface of particles or for condensing an organic compound onto the particle surface giving an organic coating, comprising a step of contacting a vapour containing an organic compound and a gaseous process stream containing flame-generated particles so as to react the organic compound with surface groups on the particles to give a chemically bonded organic functionality to the particle surface or so as to result in an organic coating.

2. A method according to claim 1, wherein a contacting system is positioned directly following the particle synthesis step where the particle-bearing gas stream contains residual temperature from the flame above 100° C., and preferably below the decomposition temperature of the organic compound in the vapour phase.

3. A method according to any of claims 1 or 2, wherein the organic compound is a silane compound, preferably R-triethoxysilane where R is any organic moiety C1 or higher, wherein even more preferably the organic compound is selected from the group of Trimethoxysilanes or Triethoxysilanes such as Trimethoxy(octyl)silane, [3-(2-Aminoethylamino)propyl] trimethoxysilane, Octyltriethoxysilane, Isobutyltriethoxysilane, 3-Aminopropyltriethoxysilane or mixtures thereof.

4. A method according to any of claims 1 or 2 wherein the particle synthesis step is a vapour flame, flame spray pyrolysis, or any other particle-generating combustion system.

5. A method according to claim 2 wherein the contacting system is a direct gas mixing chamber.

6. A method according to claim 2, wherein the contacting system consists of or comprises a porous and/or perforated, preferably cylindrical metal tube with organic vapour issued through the porous and/or perforated wall, preferably in a direction towards the main axis of the contacting system.

7. A method according to claim 2, wherein the contacting system is a cyclone.

8. A method according to claims 1 or 2, wherein functionalized particles are subsequently washed and/or dispersed in solvents, polymers, and/or grafted onto surfaces and/or subjected to chemical modification of the functionalized particles in liquid, gas or plasma treatment steps.

9. A method according to claim 8, wherein the choice of silane compound is tailored to achieve a desired particle solubility or reactivity.

10. A method according to any of claims 1 or 2, wherein the functionalized and/or coated particles are deposited onto a substrate or article to give a polymer composite layer.

11. A method according to any of claims 1 or 2, wherein the particles are based on silica and/or titania and/or zinc oxide and/or carbon, wherein preferably the particles are generated in a flame spray pyrolysis process such as in a flame of a diffusion burner, which preferably comprises a multitude of concentrical tubes, wherein a particle precursor substance is fed to the flame via the central tube, and oxygen and combustion gas or effect to the flame via a first outer annulus and a second outer annulus, respectively.

12. A method according to any of claims 1 or 2, wherein the particles are silica particles, and wherein hexamethyldisiloxane, possibly supplemented by additives, is used as the particle precursor substance.

13. A method according to any of claims 1 or 2, wherein the distance between the burner and the contacting system for contacting the vapour containing an organic compound and the gaseous process stream containing flame-generated particles is smaller than 10 cm, preferably in a range of 2-7 cm.

14. A method according to any of claims 1 or 2, wherein the vapour containing an organic compound is carried by a carrier gas stream, wherein preferably this carrier gas stream has a flow rate in the range of 0.05-0.8 l/min.

15. A method according to claim 14, wherein the vapour containing an organic compound is made by means of a bubble saturator comprising the organic compound as a liquid, through which the stream of carrier gas is bubbled.

16. A method according to any of claims 1 or 2, wherein the vapour containing an organic compound is added to the gaseous process stream containing flame-generated particles downstream of a device for the control of the temperature of the flame, preferably being given as a quenching nozzle.

17. A method according to claim 16, wherein the quenching nozzle comprises an orifice with a diameter in the range of 1 to 3 mm, preferably in the range of 1.5 mm, wherein even more preferably said quenching nozzle comprises a cooling system.

18. A method according to any of claims 1 or 2, wherein the organic compound is added to the gaseous process stream via a slit concentrical to the main axis of the process stream and wherein preferably the slit has a width in the range of 0.1 to 1 mm, preferably in the range of 0.5 mm, and wherein even more preferably the width of said slit is adjustable.

19. Particles with a chemically bonded organic functionality on the surface or with an organic compound condensed onto the particle surface giving an organic coating obtainable according to a process according to claim 1.

20. Device for carrying out a method according to claim 1, comprising at least one burner for the flame generation of particles, comprising at least one device for the introduction of a vapour containing an organic compound into the process stream comprising the generated particles, wherein said device is located substantially immediately downstream of said burner, said device being preferably distanced from the nozzle of the burner such that the temperature of the particles suits the reaction/coating with the organic compound, e.g. distanced by no more than 10 cm, and comprising at least one separation device such as a filter downstream of said device for removing the particles from the process stream, wherein preferably means are provided for facilitating the collection and transmission of the process stream through said separation device.

21. Device according to claim 20, wherein between the burner and the location of introduction of a vapour containing an organic compound into the process stream comprising the generated particles there is located a quenching nozzle.
